(19) United States
(12) Patent Application Publication
(10) Pub. No.: US 2025/0110487 A1
(43) Pub. Date: Apr. 3, 2025

(54) Method for Detecting a Production Error of an Assembly in a Manufacturing Facility

(71) Applicant: Robert Bosch GmbH, Stuttgart (DE)

(72) Inventors: Daniel Lopez Cuenca, Stuttgart (DE); Julio Alberto Gonzalez Marin, Stuttgart (DE); Thomas Anker, Reutlingen (DE)

(21) Appl. No.: 18/890,261

(22) Filed: Sep. 19, 2024

(30) Foreign Application Priority Data
Sep. 29, 2023 (DE) 10 2023 209 594.7

(51) Int. Cl. G05B 19/418

(52) U.S. Cl. CPC G05B 19/41875; G05B 2219/32335; G05B 2219/45016

(57) ABSTRACT

A method for detecting a production error of an assembly in a manufacturing facility includes (i) providing sensor data having at least two dimensions, wherein a respective dimension of the sensor data comprises measurement data with respect to the assembly, (ii) performing a dimensional reduction of the sensor data, wherein at least one feature is extracted based on the at least two dimensions of the sensor data, (iii) reconstructing the dimension-reduced sensor data based on the at least one extracted feature to provide reconstructed sensor data, (iv) determining a reconstruction error based on a comparison of the sensor data with the reconstructed sensor data, and (v) detecting the production error of the assembly based on the determined reconstruction error. Also disclosed is a computer program, a device, and a storage medium for this purpose.

This application claims priority under 35 U.S.C. § 119 to patent application no. DE 10 2023 209 594.7, filed on Sep. 29, 2023 in Germany, the disclosure of which is incorporated herein by reference in its entirety.

The disclosure relates to a method for detecting a production error of an assembly in a manufacturing facility. The disclosure also relates to a computer program, a device and a storage medium for this purpose.

### BACKGROUND

In a mass production of assemblies, in particular, thousands to millions of units of the same product are produced on a partially or fully automated production line. Depending on the complexity, the assembly may consist of more or fewer parts. In particular, these parts have manufacturing tolerances and the interplay of the parts with one another may also be subject to certain tolerances. For example, if the product is a radar sensor for motor vehicles that may comprise a printed circuit board, an antenna, an SoC (system on chip), and a plurality of low frequency components, then for example, the printed circuit board may have tolerances in terms of material properties, the antenna in terms of the main dimensions, and the SoC in terms of the performance that the semiconductor circuits can generate. Tolerances in the relative position between antenna and printed circuit board may also be present.

The tolerances may cause deviations from desired performance, which may result in an inferior or even non-functioning final product. One aim of mass production is, in particular, to create a stable manufacturing process, in which these tolerances are under control and the majority of the assemblies have performance within specifications. Even so, errors can occur in the manufacture or assembly of the assemblies, which can cause the assembly to fail or fall outside of specifications. If the manufacturing process is stable enough, the number of these faulty assemblies is not very high. For example, if the assembly is a radar sensor for the automotive sector, the antenna could be defective, the etching process on the printed circuit board could have been performed incorrectly, or the SoC could provide less or more power than indicated. There are situations in which a company that manufactures the assembly is legally obliged to guarantee a level of performance, e.g. in the case of assemblies whose malfunction could put lives at risk. For this reason, in particular, end of line (EOL) testing is performed to find these assemblies having production errors.

For example, these EOL tests are performed by measuring one or more parameters related to the performance or requirements of the assembly. For example, if the assembly is a radar sensor for the automotive sector with requirements for angle detection of targets, the performance may be estimated by measuring an antenna plot of the radar sensor in a controlled environment such as a measurement chamber, and various performance indicators such as angle error values or correlation values may be calculated in a post-processing step.

Testing for production errors in an EOL test is typically particularly error oriented, i.e., since not 100% of the requirements for an assembly can be tested, knowledge of the production error is usually required to determine the post-processing step that finds a corresponding defective assembly. This may result in a high development effort being needed to develop new EOL tests to find potential new production defects. The more complex the product, the more possible production defects that can occur and the more testing may be required to find faulty assemblies. For example, each of the post-processing steps takes some time. Time may be reduced with the appropriate development effort, but even if all EOL testing takes only a fraction of a second, this time may be relevant in production lines where the cycle time is only a few seconds.

The inputs for the EOL test, for example based on a plurality of angular points of the antenna plot and various measurement parameters of the system on a chip (SoC), as well as adjustments for each transmitter and noise for each receiver, as well as cross-coupling parameters, may correlate. For each individual measurement, in particular, there are several post-processing steps or error detection steps, each of which may be designed for a different error mode. However, the correlations between different measurement data are not used, for example, in the prior art. If a new type of error is detected, a new post-processing step or error detection step is therefore particularly required. If a faulty assembly is present, multiple limits may be exceeded, but the sensitivity of the individual limits may be low. That is to say, if a faulty assembly with a small error is present, disadvantageously, none of the limits may be exceeded.

### SUMMARY

The subject matter of the disclosure is a method, a computer program, a device, and a computer-readable storage medium having the features set forth herein. Further features and details of the disclosure will emerge from the description and the drawings. Features and details which are described in connection with the method according to the disclosure naturally also apply in connection with the computer program according to the disclosure, the device according to the disclosure and the computer-readable storage medium according to the disclosure, and vice versa in each case, so that reference is or can always be made to the individual aspects of disclosure.

The subject matter of the disclosure is in particular a method for detecting a production error of an assembly in a manufacturing facility, comprising the steps of:
providing sensor data having at least two dimensions, wherein a respective dimension of the sensor data comprises measurement data relative to the assembly,
performing a dimensional reduction of the sensor data, wherein at least one feature is extracted based on the at least two dimensions of the sensor data,
reconstructing the dimension-reduced sensor data based on the at least one extracted feature to provide reconstructed sensor data,
determining a reconstruction error based on a comparison of the sensor data with the reconstructed sensor data,
detecting the production error of the assembly based on the determined reconstruction error.
   The production error may be a wide-ranging defect in the assembly, which is reflected in the sensor data of the respective assembly. For example, in the event that the assembly is a radar sensor, the antenna could be defective, the etching process on the printed circuit board could have been performed incorrectly, or the SoC (System on a Chip) could provide less or more power than indicated. The measurement data may result from various types of measurements on the assembly or when using the assembly. For example, in the case of a radar sensor, the measurement data may result from measurements of different angular points of an antenna plot or with different measurement parameters. For example, the dimension reduction may be a reduction of a number of dimensions present in the sensor data provided to a number of the extracted features. The features that are extracted may thus represent the dimensions of the dimension-reduced sensor data. Based on the reconstruction error, the assembly in particular determines how far the sensor data deviates from normal or reference values that are given in an assembly without a production error. The method may advantageously perform detection based on the sensor data with the at least two dimensions of the production errors. In other words, multiple input variables, i.e. the at least two pieces of measurement data, are thus combined by the method, whereby detection sensitivity can advantageously be increased.

Also, it is optionally conceivable that determining the reconstruction error comprises the following step:
calculating a Euclidean distance between the sensor data and the reconstructed sensor data to determine the reconstruction error based on the calculated Euclidean distance.
   The Euclidean distance may also be referred to as Euclidean distance, and preferably corresponds to a length or an amount of a connection vector of two points or vectors. The Euclidean distance may thus be used to calculate a distance between points in an n-dimensional space, wherein this distance in the present case may correspond to the reconstruction error.

Further, it is optionally contemplated that detecting the production error comprises the steps of:
defining a threshold value for the reconstruction error,
comparing the reconstruction error with the defined threshold value to detect the production error of the assembly.
   The threshold value can thus be advantageously defined individually depending on a given application. For example, even with a higher deviation, a particular type of assembly may still be of sufficiently good quality. The threshold may also be determined and defined by trial and error. Further, the threshold may also be automatically defined based on past detections of the production error of the assembly.

Furthermore, it may be contemplated within the scope of the disclosure that the method is further performed using a machine learning model, preferably a neural network, quite preferably an auto-encoder, for example a variation auto-encoder. By using a machine learning model, in particular a neural network such as an auto-encoder, a continuous improvement can advantageously be provided because the machine learning model is based on new data to which it is able to optimize its weights to allow for more precise detection of the production errors of the assembly.

It may further be possible for the machine learning model to have been trained based on the steps of:
providing reference data having at least two dimensions, wherein a respective dimension of the reference data comprises measurement data relative to an assembly without production errors,
performing a dimensional reduction of the reference data, wherein at least one reference feature is extracted from the reference data based on the at least two dimensions of the reference data,
reconstructing the dimension-reduced reference data based on the at least one extracted reference feature,
determining a reconstruction error based on a comparison of the reference data with the reconstructed reference data.
   In so doing, the steps of performing the dimensional reduction, reconstructing the dimension-reduced reference data, and determining the reconstruction error may be performed until the reconstruction error passes below a defined boundary value. Simply stated, with this training, the machine learning model is intended to learn to reduce the number of dimensions of the reference data by extracting the at least one reference feature, in order to subsequently reconstruct the reference data as precisely as possible on the basis of the extracted reference feature. It is particularly contemplated that the measurement data of the reference data and the measurement data of the sensor data were each determined in a same manner. For example, measurement data of a given dimension in the reference data and in the sensor data may result from a measurement of the same angular points of an antenna plot of the assembly, in case it is configured as a radar sensor.

Preferably, the assembly may be a radar sensor and the measurement data of the particular dimension of the sensor data may result from measurements by the radar sensor and/or on the radar sensor. For example, the measurement data may result from measurements of an input signal strength, a reflected signal, a resolution, a range, a frequency stability, and/or a noise level.

Furthermore, it is contemplated that the method will be performed as part of a quality test, in particular an end-of-line test, of manufacturing. Particularly in end-of-line quality testing, the method may be advantageous because the focus is on being able to decide whether or not a particular assembly has a production error, i.e., is defective. The method may advantageously allow a general decision regarding the presence of a production error based on a plurality of input variables, wherein the detection may advantageously be very sensitive due to the combination of the plurality of input variables. Since finer differentiation, as to exactly what the error of the assembly is, may be less important in end-of-line tests, the method can thus be particularly advantageous.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features and details of the disclosure will emerge from the following description, in which exemplary embodiments of the disclosure are described in detail with reference to the drawings. The features mentioned in the claims and in the description can each be essential to the disclosure individually or in any combination. Shown are:

FIG. 1 a schematic representation of a method, a device, a storage medium, and a computer program according to exemplary embodiments of the disclosure,

FIG. 2 a schematic visual representation of a part of a method according to exemplary embodiments of the disclosure,

FIG. 3 a schematic representation of the sensor data from a plurality of assemblies according to exemplary embodiments of the disclosure,

FIG. 4 a schematic representation of a histogram of measurement data according to exemplary embodiments of the disclosure,

FIG. 5 a schematic representation of a histogram of additional measurement data according to exemplary embodiments of the disclosure,

FIG. 6 a schematic representation of the sensor data of the plurality of assemblies based on two extracted features according to exemplary embodiments of the disclosure,

FIG. 7 a schematic representation of a histogram based on an extracted feature according to exemplary embodiments of the disclosure,

FIG. 8 a schematic representation of a histogram based on a further extracted feature according to exemplary embodiments of the disclosure,

FIG. 9 a schematic representation of the sensor data of the plurality of assemblies after a dimensional reduction according to exemplary embodiments of the disclosure,

FIG. 10 a schematic representation of the sensor data of the plurality of assemblies based on two extracted features after the dimensional reduction according to exemplary embodiments of the disclosure,

FIG. 11 a schematic visual representation of a histogram of the reconstruction error according to exemplary embodiments of the disclosure,

### DETAILED DESCRIPTION

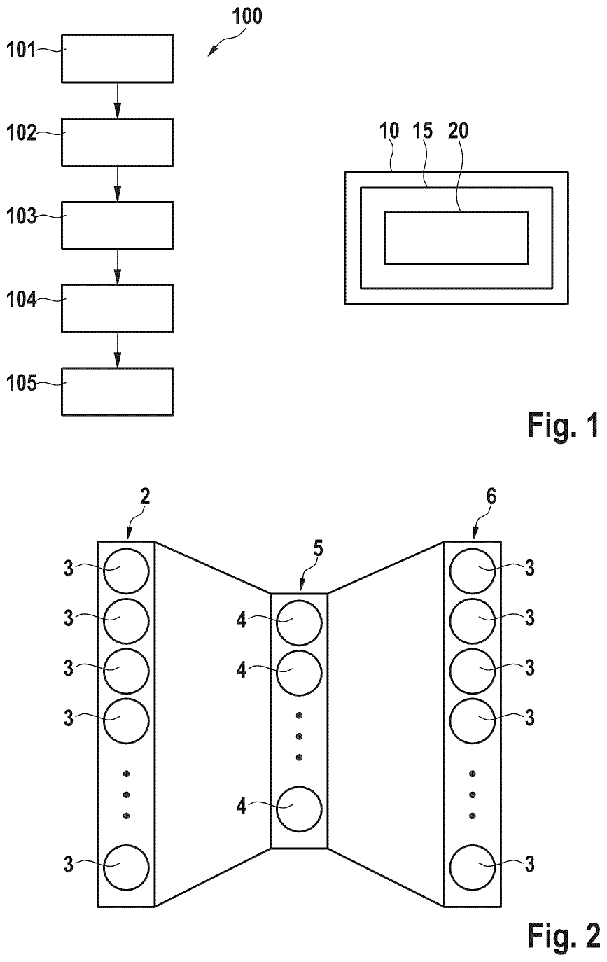

FIG. 1 schematically illustrates a method 100, a device 10, a storage medium 15 and a computer program 20 according to exemplary embodiments of the disclosure.

FIG. 1 particularly shows a method 100 for detecting a production error of an assembly 1 in a manufacturing facility according to exemplary embodiments of the disclosure. In a first step 101, in particular, sensor data 2 with at least two dimensions 3 is provided, wherein a respective dimension 3 of the sensor data 2 each comprises measurement data with respect to the assembly 1. In a second step 102, a dimensional reduction of the sensor data 2 is preferably carried out, wherein at least one feature 4 is extracted based on the at least two dimensions 3 of the sensor data 2. In a third step 103, preferably, the dimension-reduced sensor data 5 is reconstructed based on the at least one extracted feature 4 to provide reconstructed sensor data 6. In a fourth step 104, a reconstruction error is determined based on a comparison of the sensor data 2 with the reconstructed sensor data 2. In a fifth step 105, the production error of assembly 1 is detected based on the determined reconstruction error.

In the following sections, a method for detecting production errors of an assembly 1 is described, which, for example, can provide the following advantages. The test is in particular no longer based on performance indicators or a requirement for the assembly 1, but rather on statistical behavior of the assembly 1. Furthermore, production errors may be detected regardless of what the error source is. In particular, the method according to exemplary embodiments results in a single value (in particular the reconstruction error), regardless of how many different pieces of measurement data are provided for the sensor data 2. The output, i.e. in particular the reconstruction error, can be compared to at least one threshold value, which can be specified.

Often, for calibration or testing purposes, in particular, multiple measurements must be taken on an assembly 1. These measurements may be represented by a point (or vector) of dimension N, wherein N is the number of pieces of measurement data based on measurements taken. Starting from statistics of a plurality of measured assemblies 1, a statistical representation of assembly 1 can be obtained by including all points in this N-dimensional space. For example, the points for a particular assembly 1 are not randomly distributed across the N-dimensional space, but instead accumulate in clusters or follow certain trajectories. This may be due to the fact that the various measurements forming the N-dimensional space for a particular assembly have correlations with one another.

For example, if the assembly 1 is a radar sensor for the automotive sector, in which the antenna plot for different angular points is measured, the amplitudes of two adjacent angular points have particularly high correlations. If this is the case with the product to be tested, this fact can be used as an advantage in order to detect production errors of the assemblies 1, i.e. faulty assemblies. For example, faulty assemblies 1 have different correlations between N dimensions 3, which may mean that this faulty assembly 1 does not propagate in the same paths/clusters as assemblies without production errors 1′. The method according to exemplary embodiments of the disclosure preferably utilizes the correlations between the various measurements of assembly 1 to separate the assemblies 1 that are outside of statistics (faulty assemblies 1) by application of dimensional reduction techniques.

FIG. 2 shows in particular how the method according to exemplary embodiments transforms sensor data 2 with N dimensions 3 into dimension-reduced sensor data 5 in a latent space with M extracted features 4 (M<N), wherein the extracted features 4 may be combinations of the original dimensions 3 and may not necessarily represent physical features of assembly 1. Then, preferably, the reconstruction is performed back to the original N-dimensional space to obtain reconstructed sensor data 6. Because M<N, some information may be lost in this process and a reconstruction error may occur. For example, the reconstruction error may be determined by calculating the Euclidean distance between the sensor data 2 and the reconstructed sensor data 6 (reconstruction error=|sensor data 2−reconstructed sensor data 6|). A challenge may be to select as few dimensions 3 as possible from this latent space, i.e., the dimension-reduced sensor data 5, while keeping the reconstruction error for assemblies without production error 1′ small. To this end, unsupervised learning may be performed based on training using reference data. For example, after one of the training sessions, a new assembly 1 may be tested. The smaller the reconstruction error, the more the new assembly resembles the assemblies used for training without production error 1′ of the reference data. If a faulty assembly 1, i.e. an assembly with production error 1, is tested, the error is preferably several orders of magnitude higher than the assemblies without production error 1′ and the faulty assembly 1 can be filtered out very easily.

The method described above may further be used to detect deviations in the manufacturing process. For example, if the reconstruction error of assemblies without production error 1′ increases slowly (or rapidly) over time, this may be indicative of deviations in the manufacturing process. For example, recalibration or maintenance of the gauges may be required.

Various methods of dimensional reduction are known in the prior art, including linear methods such as PCA (principal component analysis), FA (factor analysis), LDA (linear discriminant analysis) or truncated SVD (truncated singular value decomposition). Further, non-linear methods are known such as kernel PCA, t-distributed Stochastic Neighbor Embedding (t-SNE), Multidimensional Scaling (MDS), Isometric Mapping (Isomap), Replicator neural networks, auto-encoders or variational auto-encoders.

In accordance with exemplary embodiments, PCA and auto-encoders may be preferred due to the following advantages.

The PCA preferably attempts to project data into new linear dimensions that maximize the variance of the data. If the original dimensions N only have linear dependencies, the new dimensions M, i.e. the extracted features 4, will be particularly linearly independent. The first dimensions of the calculation may be more important because they contain the most information.

Advantageously, only a small computational effort may be necessary to complete the PCA. Furthermore, the PCA may be easy to implement. The projection of a new point into the new dimensions M, i.e. in particular the extraction of features 4, as well as the reconstruction of the data in the original N-dimensional space may require only a small computational effort.

Furthermore, the PCA can be deterministic and easy to understand. The new dimensions 3 preferably depend only on the input data, i.e. the sensor data 2. For example, in the calculation, there are no random factors such as parameter initializations. If the calculation is repeated with the same data, the same results are obtained in particular. This is particularly advantageous for assemblies in which random events are difficult to explain or model.

In the following sections, it will be explained with reference to FIGS. 3 to 10 how the method according to exemplary embodiments of the disclosure can be used to detect production errors in assemblies 1 if the sensor data 2 has N=2 dimensions and M=1 features 4 are extracted for the dimension-reduced sensor data 5. More dimensions 3 may be required depending on the type of assembly 1.

For example, assume that there are 10003 assemblies 1. For example, two measurements were taken for each assembly 1 to provide two pieces of measurement data. 10000 of the assemblies 1′ do not have a production error and are therefore OK and three of the assemblies 1 have a production error and are outside of statistics. It can be seen in FIG. 3 that the assemblies without production error 1′ are distributed along the line x=y of the diagram based on the measurement data and the assemblies with production error 1 are outside of this range.

Using the method according to exemplary embodiments of the disclosure, for example with the PCA, features 4 can be extracted. For example, the extracted features 4 may have no physical meaning but include information about the assemblies. The extracted features 4 may be evenly arranged so that higher dimensions 3 contain less information.

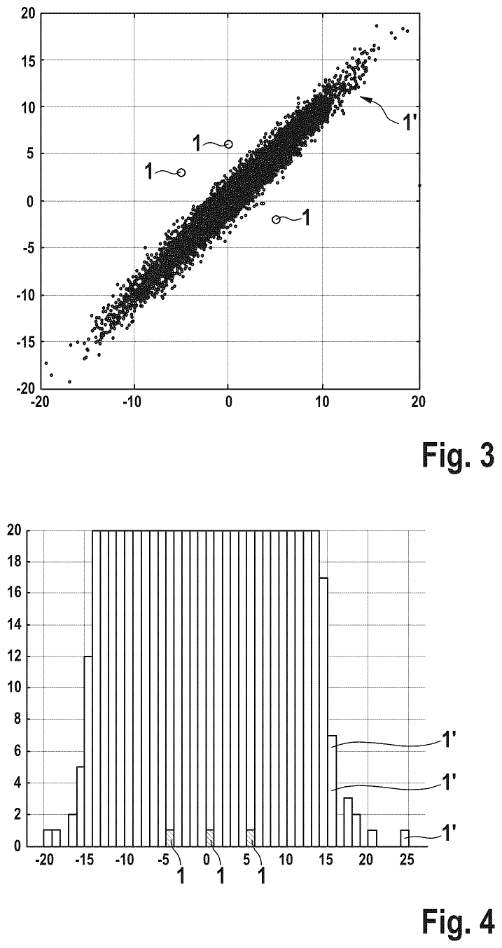

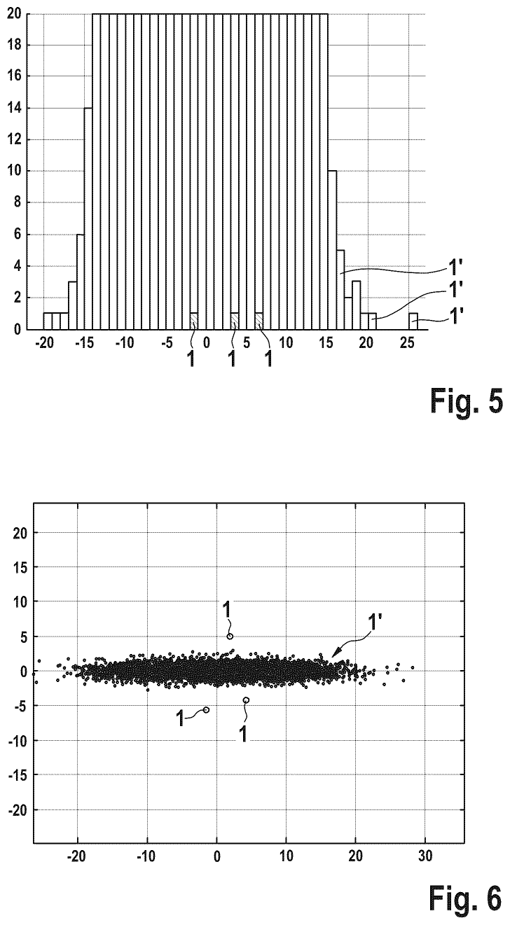

FIG. 3 illustrates a two-dimensional example. FIGS. 4 and 5 show histograms for each of the two dimensions 3 of the respective measurement data. It is noticeable, for example, that the faulty assemblies 1 are also within the statistics, so that it is in particular not possible to distinguish them from the assemblies without production error 1′.

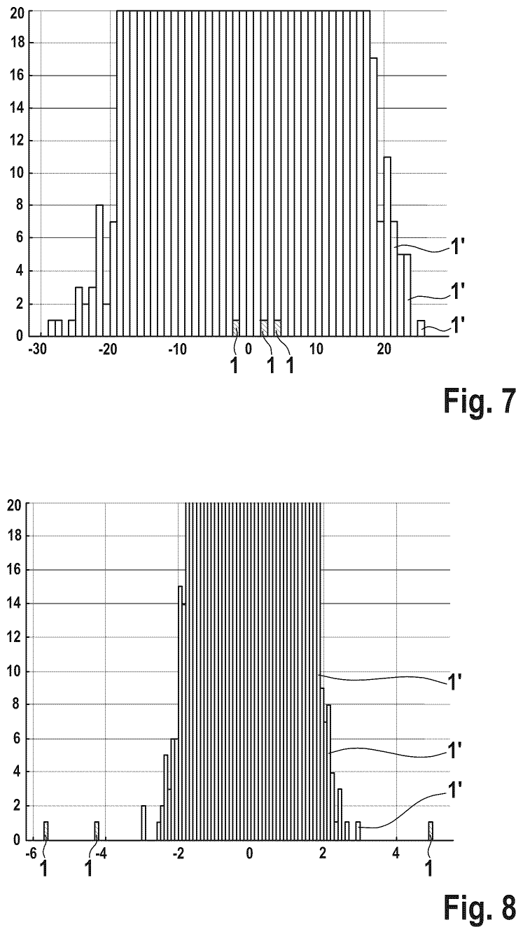

FIG. 6 shows a space recreated by the extracted features 4. Based thereupon, new histograms (see FIG. 7 and FIG. 8) of the respective extracted features 4 may be created. In the histogram of one of the extracted features 4, which is shown in FIG. 8, for example, a deviation can be seen in the faulty assemblies 1. The faulty assemblies 1 thus have high values for one of the extracted features 4. For this two-dimensional example, therefore, the production errors of the faulty assemblies 1 can be detected by using this second histogram. For higher dimensional cases, an additional step may be performed.

In higher-dimensional cases, a plurality of the dimensions 3 can be ignored, i.e., a dimension reduction of more than one dimension 3 can be carried out. The number of dimensions 3 to be ignored may depend on how much the original dimensions 3 correlate with each other. For cases with very high correlations, ignoring many dimensions 3 can lead to significantly better results.

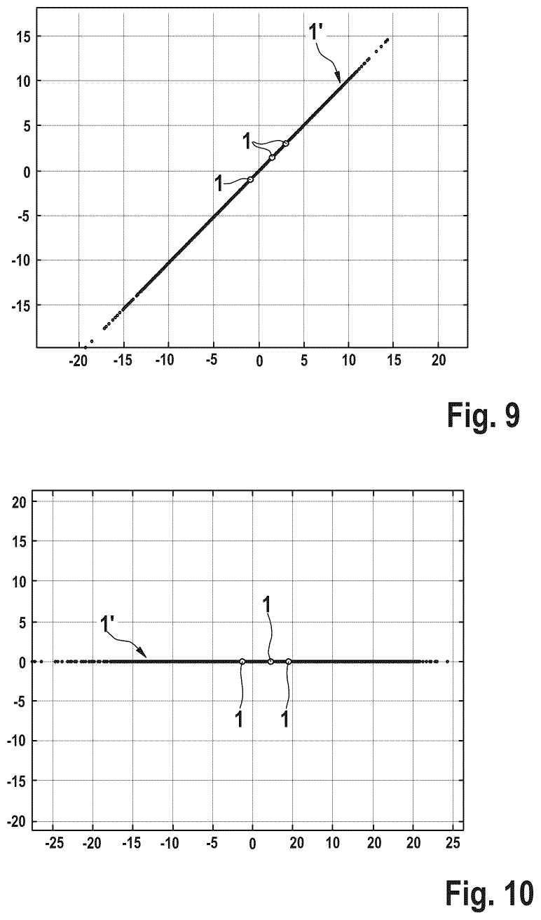

After ignoring the second dimension 3, the assemblies may again be shown in the original and new space as seen in FIG. 9 (original space) and FIG. 10 (new space with the extracted features 4).

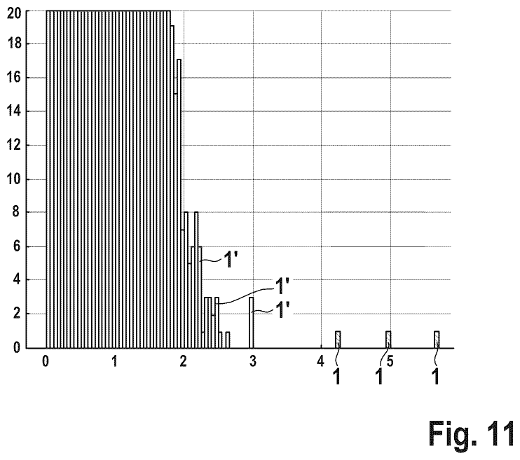

In the case of the original space, the reconstructed sensor data 6 of the assemblies can now be compared to the original sensor data 2 to determine a reconstruction error. A Euclidean distance may be calculated for this purpose. A histogram of the reconstruction error is shown in FIG. 11. It can be seen that the assemblies with production error 1 have significantly higher errors than the assemblies without production error 1′. For a maximum allowable reconstruction error, a threshold may be defined to detect the production error in the assemblies 1.

The higher the original dimensions 3 and the higher the linear correlation between the original features 4, the higher the resulting reconstruction error may be.

An auto-encoder, in particular a variation auto-encoder, may further be used for dimensional reduction. Auto-encoders preferably project original data, in particular the sensor data 2, into a new latent space with extracted features 4 and fewer dimensions. Moreover, non-linear correlations may be considered so that it may be particularly advantageous to compress assemblies 1 with non-linear correlations between their dimensions.

The projection of a new point into the new dimensions 3, i.e., the extraction of features 4, as well as the reconstruction of the data in the original N-dimensional space, may be performed with little computational effort by application of a non-linear function, such as a rectifier function.

In contrast to the PCA method, the latent space of auto-encoders may differ between different training runs due to the potentially random initialization of the initial neural network. The latent space for simple auto-encoders is particularly disordered (as opposed to, e.g., variation auto-encoders).

The auto-encoder machine learning model may first be trained with a set of typical measurement data from assemblies without production error 1′. During this training process, in particular, an encoder part (of the reference data projected to the latent space, i.e., which reduces the reference data, wherein features 4 are extracted) and a decoder part (which reconstructs the dimension-reduced reference data from the latent, i.e., dimension-reduced space back to the original dimensions 3) are trained. The trained machine learning model may then be applied to sensor data 2. The corresponding reconstructed sensor data 6 is preferably very close to the reference data when the new sensor data 2 follows the same distribution as the reference data. In the case of outliers (sensor data 2 observed with a different correlation between its dimensions 3 than in the reference data), the auto-encoder machine learning model preferably has difficulty reconstructing the data and thus results in a high reconstruction error, thereby detecting a production error of an assembly 1. A range-specific measure for the difference (e.g., MSE) may be used for the reconstruction error.

In accordance with exemplary embodiments, this is an end of line (EoL) test of a manufacturing process. In particular, there are several different measurements for respective measurement data that can be supplied to the method according to exemplary embodiments as sensor data 2. For example, in conventional prior art testing, each measurement is tested separately without combining the measurements, typically requiring at least as many independent calculations as measurements, sometimes even more. In the method according to exemplary embodiments of the disclosure, advantageously, multiple pieces of measurement data may be combined as the sensor data 2 and fed into the production failure detection algorithm, which may advantageously simplify implementation, reduce complexity, and improve sensitivity.

A result of the method according to exemplary embodiments of the disclosure is preferably a single error value based on the reconstruction error. A threshold may be defined to detect production errors of assemblies 1. An EoL test can thus be advantageously greatly simplified.

All measurement data may advantageously be taken into account in a combined manner in the sensor data 2 with the method according to exemplary embodiments and the reconstruction error may be used to detect production errors of the assemblies 1.

The use of the reconstruction error to detect production errors of the assemblies 1 takes into account, in particular, correlations between different parameters, i.e. measurement data, and may advantageously increase detection sensitivity by at least a value of 100 as compared to performance-based algorithms of the prior art. This has the advantage, for example, that the same or higher sensitivity can be achieved than with performance-based algorithms with fewer measurements. The effort for calculating threshold values can also be advantageously reduced, since only one threshold value may be necessary for the reconstruction error.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for detecting a production error of an assembly in a manufacturing facility, comprising:
providing sensor data having at least two dimensions, wherein a respective dimension of the sensor data comprises measurement data relative to the assembly;
performing a dimensional reduction of the sensor data, wherein at least one feature is extracted based on the at least two dimensions of the sensor data;
reconstructing the dimension-reduced sensor data based on the at least one extracted feature to provide reconstructed sensor data;
determining a reconstruction error based on a comparison of the sensor data with the reconstructed sensor data; and
detecting the production error of the assembly based on the determined reconstruction error.

2. The method according to claim 1, wherein determining the reconstruction error comprises:
calculating a Euclidean distance between the sensor data and the reconstructed sensor data to determine the reconstruction error based on the calculated Euclidean distance.

3. The method according to claim 1 wherein detecting the production error comprises:
defining a threshold value for the reconstruction error, and
comparing the reconstruction error with the defined threshold value to detect the production error of the assembly.

4. The method according to claim 1, further comprising using a machine learning model.

5. The method according to claim 4, wherein the machine learning model was trained based on the following steps:
providing reference data having at least two dimensions, wherein a respective dimension of the reference data comprises measurement data relative to an assembly without production errors,
performing a dimensional reduction of the reference data, wherein at least one reference feature is extracted from the reference data based on the at least two dimensions of the reference data,
reconstructing the dimension-reduced reference data based on the at least one extracted reference feature, and
determining a reconstruction error based on a comparison of the reference data with the reconstructed reference data,
wherein the steps of performing the dimensional reduction of the reference data, reconstructing the dimension-reduced reference data, and determining the reconstruction error are performed until the reconstruction error passes below a defined boundary value.

6. The method according to claim 1, wherein:
the assembly is a radar sensor, and
the measurement data of the respective dimension of the sensor data results from measurements by the radar sensor and/or on the radar sensor.

7. The method according to claim 1, wherein the method is carried out as part of a quality test.

8. A computer program comprising instructions that, when the computer program is executed by a computer, cause the computer to carry out the method according to claim 1.

9. A device for data processing which is configured to carry out the method according to claim 1.

10. A computer-readable storage medium comprising instructions which, when executed by a computer, cause it to carry out the steps of the method according to claim 1.

11. The method according to claim 1, further comprising using a neural network.

12. The method according to claim 1, further comprising an auto-encoder.

13. The method according to claim 1, wherein the method is carried out as part of an end-of-line test of manufacturing.
